(19) United States
(12) Patent Application Publication
(10) Pub. No.: US 2009/0113959 A1
(43) Pub. Date: May 7, 2009

(54) AUTOMOBILE STEERING WHEEL LOCK

(76) Inventor: Pin-Ying YU, Tainan City (TW)

Correspondence Address: Pin-Ying YU, P. O. BOX 90, Tainan City, 70499, TW

(21) Appl. No.: 11/935,370

(22) Filed: Nov. 5, 2007

(51) Int. Cl. B60R 25/02

(52) U.S. Cl. 70/211

(57) ABSTRACT

An automobile steering wheel lock includes a foundation base with a lock holder, an insert slot formed between the foundation base and the lock holder. The foundation base has its underside secured with a baffle plate having its front portion formed with a clasping recess. The lock holder is disposed with an accommodating chamber received therein with a push-in lock provided with an engage pin and a spring, and the engage pin can be pressed to extend in the insert slot. A resisting rod is fixed with a positioning insert bar to be inserted in the insert slot. The positioning insert bar is bored with at least one pin hole for an engage pin to be inserted therein and has one side provided with a lengthwise slide recess, and a fixing pin is inserted through the accommodating chamber and fixed in the slide recess of the positioning insert bar.

### BACKGROUND OF THE INVENTION

1. Field of the Invention

This invention relates to an automobile steering wheel lock, particularly to one to be locked on an automobile steering wheel, able to prevent an automobile as well as a safety airbag in the center of the steering wheel from being burglarized.

2. Description of the Prior Art

A conventional automobile steering wheel lock 1, as shown in FIG. 1, includes a main body 10 having one end fixed with a resisting rod 11. The main body 10 is provided with a lock core 12 and has its lower side disposed with a holding member 13 and its front side secured with a clasping member 14. The holding member 13 and the clasping member 14 of the main body 10 are covered on the steering wheel 15 and the resisting rod 11 is resisted on the instrument panel 16 of an automobile to firmly fix the steering wheel 15 in position and keep it from rotating by means of the steering wheel lock 1, thus preventing the automobile from being burglarized.

However, the conventional automobile steering wheel lock 1 can only prevent the automobile from being stolen, but cannot protect a safety airbag in the steering wheel 15 from being burglarized. A burglar can easily steal the safety airbag only by prying open the center cover of the steering wheel 15.

### SUMMARY OF THE INVENTION

The objective of this invention is to offer an automobile steering wheel lock able to protect a safety airbag in the steering wheel from being burglarized and also having effect of burglary prevention of the automobile.

The main feature of this invention is that the steering wheel lock includes a foundation base assembled thereon with a lock holder, with an insert slot formed between the lock holder and the foundation base. The lock holder is formed with an accommodating chamber having its inner wall bored with an insert hole and a pin hole respectively communicating with the insert slot. The foundation base has its underside secured with a baffle plate having its front portion bent downward and inward to form a clasping recess. A push-in lock to be received in the accommodating chamber of the foundation base is disposed with a fixing base having a lock core installed therein. A holding plate is positioned under the lock core, having its underside fixed with a vertical engage pin aligned to the insert hole in the inner wall of the accommodating chamber of the lock holder, and a spring is fitted on the engage pin and positioned under the holding plate. A resisting rod to be assembled at one side of the foundation base has its underside fixed with a retaining hook and its front end secured with a positioning insert bar bored with at least one pin hole and having one side provided with a lengthwise slide recess. A fixing pin is to be inserted through the pin hole in the inner wall of the accommodating chamber of the lock holder and fixed in the slide recess of the positioning insert bar.

Another feature of this invention is that the steering wheel lock includes a foundation base installed with a circuit board, a battery and a beeper in the interior. The circuit board is disposed thereon with a micro-switch and at least one warning lamp, which is extended out of the topside of the foundation base. The foundation base is assembled thereon with a lock holder, and between the lock holder and the foundation base is formed an insert slot having its bottom bored with a through hole. The micro-switch is provided with a press member extended in the through hole of the insert slot. The lock holder is provided with an accommodating chamber having its inner wall bored with an insert hole and a pin hole respectively communicating with the insert slot, and the foundation base further has its underside secured with a baffle plate having its front portion bent downward and inward to form a clasping recess. A push-in lock to be received in the accommodating chamber of the foundation base is provided with a fixing base fitted therein with a lock core having its lower side disposed with a holding plate having its underside fixed with a vertical engage pin aligned to both the insert hole in the inner wall of the accommodating chamber of the lock holder and the through hole at the bottom of the insert slot. A spring is fitted on the engage pin and positioned under the holding plate. A resisting rod to be fixed at one side of the foundation base has its underside secured with a retaining hook and its front end provided with a positioning insert bar bored with at least one pin hole and having one side edge disposed with a lengthwise slide recess. A fixing pin is to be inserted through the pin hole in the inner wall of the accommodating chamber and fixed in the slide recess of the positioning insert bar.

### BRIEF DESCRIPTION OF DRAWINGS

This invention will be better understood by the referring to the accompanying drawings, wherein:

FIG. 1 is a perspective view of a conventional automobile steering wheel lock;

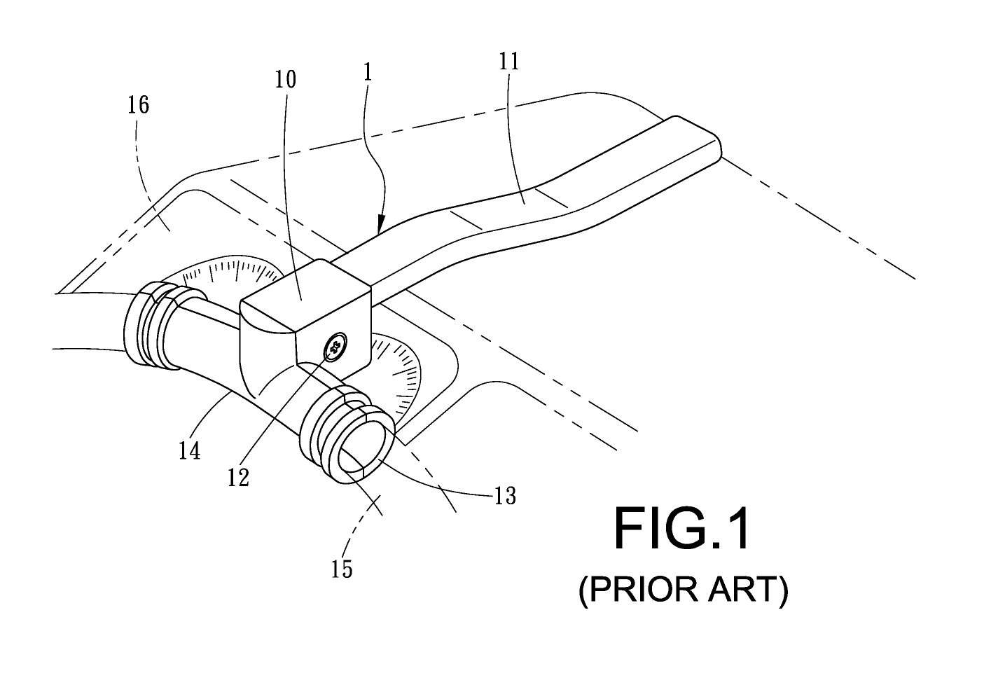

FIG. 2 is an exploded perspective view of an automobile steering wheel lock in the present invention;

FIG. 3 is a perspective view of the automobile steering wheel lock in the present invention;

FIG. 4 is a cross-sectional view of the automobile steering wheel lock in the present invention;

FIG. 5 is an upper view of the automobile steering wheel lock in the present invention;

FIG. 6 is a cross-sectional view of the automobile steering wheel lock in an unlocked condition in the present invention;

FIG. 7 is an upper view of the automobile steering wheel lock in an unlocked condition in the present invention; and

FIG. 8 is a perspective view of the automobile steering wheel lock in a locked condition in the present invention.

### DETAILED DESCRIPTION OF THE PREFERRED EMBODIMENT

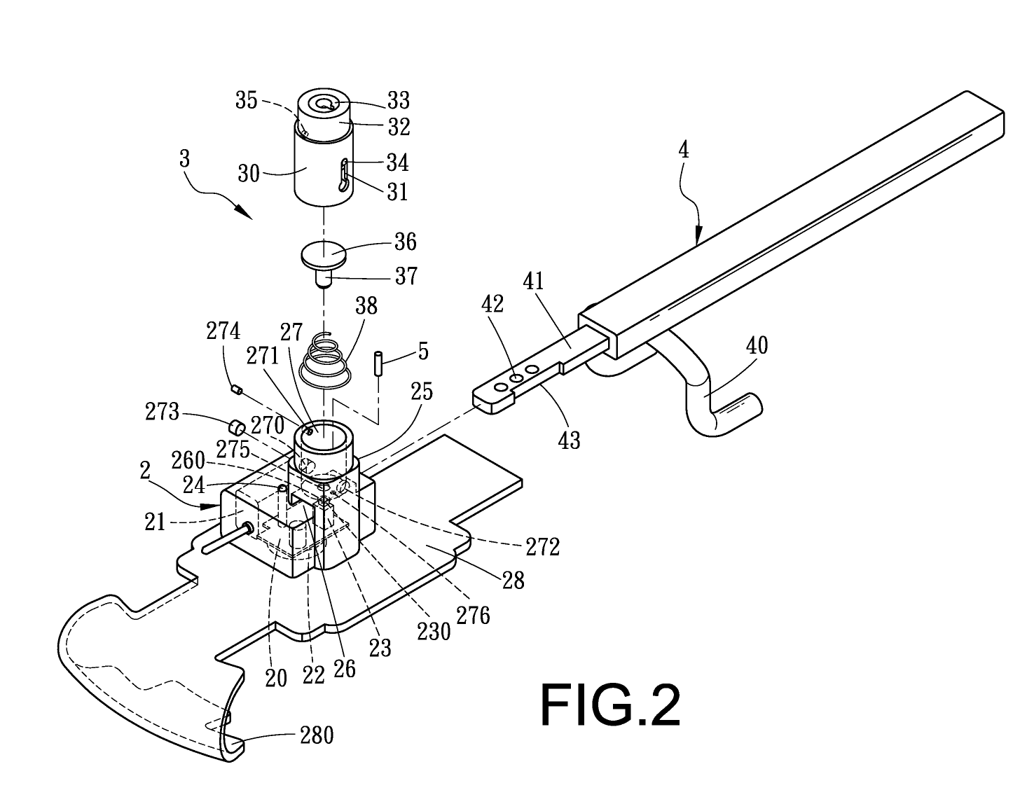

A preferred embodiment of an automobile steering wheel lock in the present invention, as shown in FIG. 2, mainly includes a foundation base 2, a push-in lock 3, a resisting rod 4 and a fixing pin 5 combined together.

The foundation base 2 is provided with a circuit board 20, a battery 21 and a beeper 22 in the interior. The circuit board 20 is disposed thereon with a micro-switch 23 and a warning lamp 24 extended out of the topside of the foundation base 2. The foundation base 2 is mounted thereon with a lock holder 25, and between the lock holder 25 and the foundation base 2 is formed an insert slot 26 having its bottom bored with a through hole 260 for a press member 230 of the micro-switch 23 to be inserted therein. The lock holder 25 is provided in the center with an accommodating chamber 27 having its circumferential wall bored with an insert hole 270, a pin hole 271 and a positioning recess 272 opposite to the insert hole 270, with a stopper 273 clogged in the insert hole 270 and a fixing pin 274 inserted in the pin hole 271. The accommodating chamber 27 of the lock holder 25 has its inner wall bored with an insert hole 275 and a pin hole 276 respectively communicating with the insert slot 26. The foundation base 2 further has its underside secured with a baffle plate 28, which has its front portion curved both downward and inward to form a clasping recess 280.

The push-in lock 3 to be received in the accommodating chamber 27 of the foundation base 2 is provided with a fixing base 30 bored with a lengthwise slot 31 and received therein with a lock core 32, which is fitted with a rotary member 33 in the interior and has its outer wall fixed with an engage stud 34 inserted in the lengthwise slot 31 of the fixing base 30. The fixing base 30 further has its outer wall bored with a positioning pin hole 35. A holding plate 36 is positioned under the lock core 32 and has its underside secured with a vertical engage pin 37 having its outside fitted thereon with a spring 38 positioned beneath the holding plate 36, and the engage pin 37 and the spring 38 are together received in the interior of the fixing base 30.

The resisting rod 4 to be assembled at one side of the foundation base 2 has its underside fixed with a retaining hook 40 and its front end secured with a positioning insert bar 41 axially bored with at least one pin hole 42 and having a slide recess 43 cut at one side.

The fixing pin 5 is to be inserted through the pin hole 276 in the inner wall of the accommodating chamber 27 of the foundation base 2 and fixed in the slide recess 43 of the positioning insert bar 41.

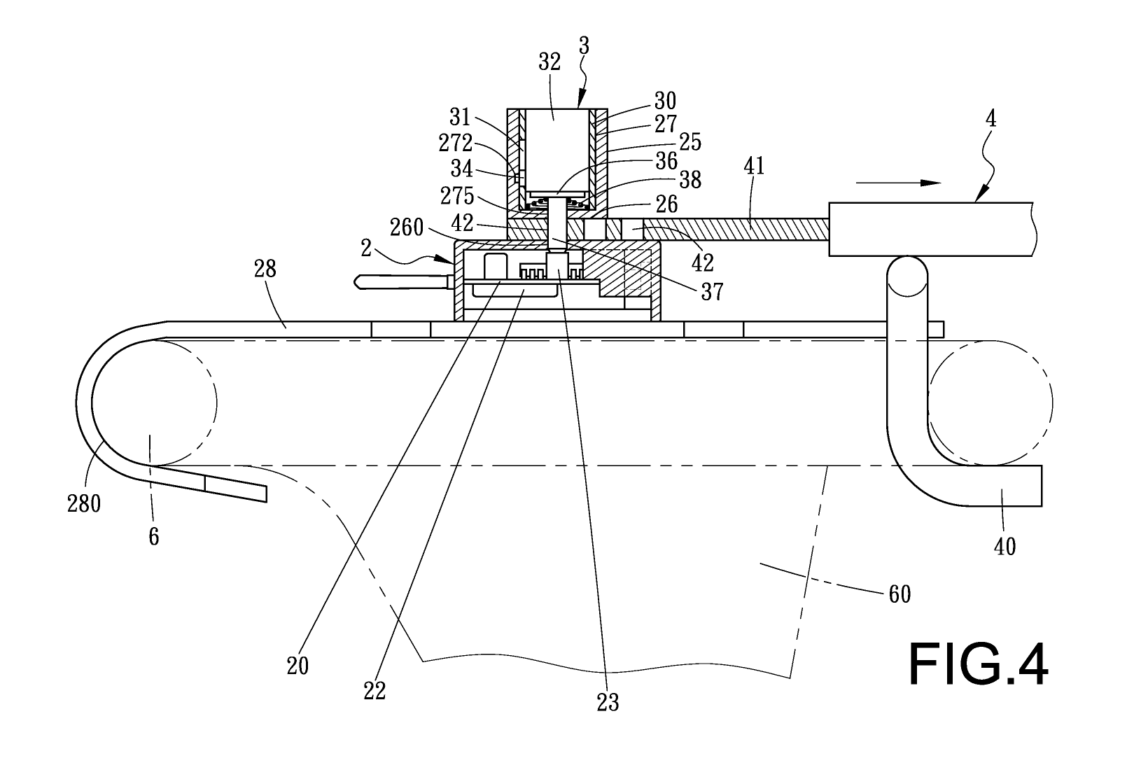

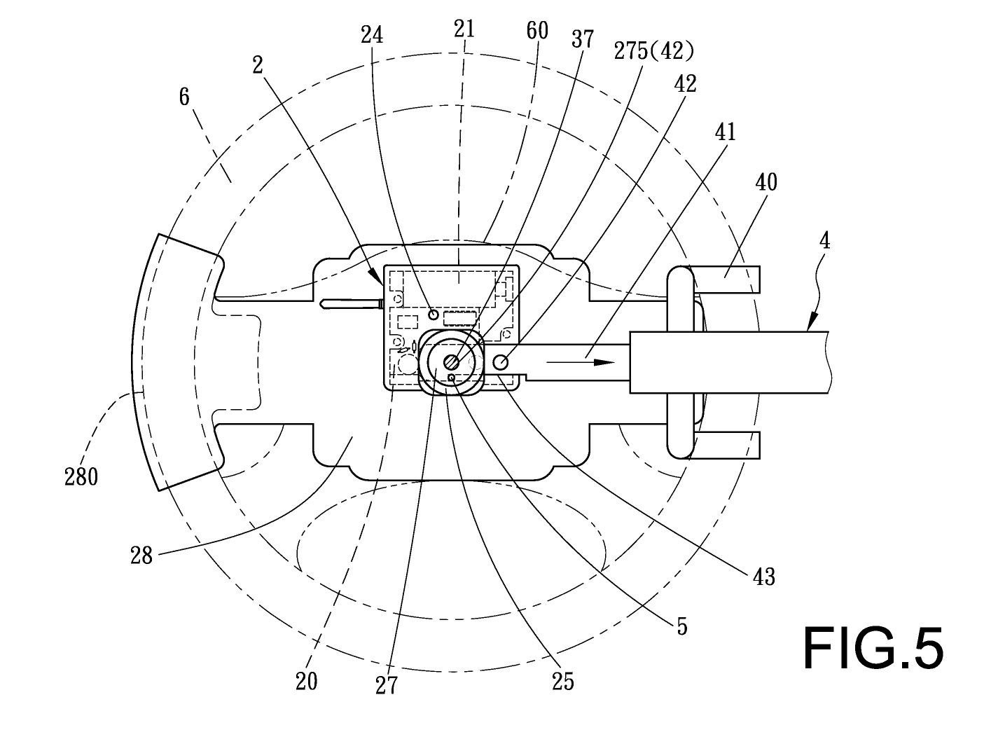

In assembling, referring to FIGS. 2 to 5, firstly, the positioning insert bar 41 of the resisting rod 4 is inserted in the insert slot 26 of the foundation base 2, and the fixing pin 5 is inserted through the pin hole 276 in the inner wall of the accommodating chamber 27 of the foundation base 2, having its lower end inserted in the slide recess 43 of the positioning insert bar 41 positioned in the insert slot 26 to prevent the resisting rod 4 from disengaged from the foundation base 2. Next, the push-in lock 3 is received in the accommodating chamber 27 of the foundation base 2, and the spring 38 and the engage pin 37 of the push-in lock 3 are positioned in the interior of the fixing base 30, with the spring 38 fitted on the engage pin 37 and having its upper end pushing against the holding plate 36 on the engage pin 37 to let the topside of the holding plate 36 closely contact with the underside of the lock core 32. Subsequently, the positioning pin hole 35 of the fixing base 30 is aligned to the pin hole 271 in the circumferential wall of the accommodating chamber 27 of the foundation base 2, and the fixing pin 274 is inserted in both the pin hole 271 of the foundation base 2 and the positioning pin hole 35 of the fixing base 30 to secure the fixing base 30 in the accommodating chamber 27 of the foundation base 2. Then, the stopper 273 is clogged in the insert hole 270 in the circumferential wall of the accommodating chamber 27, and the lock core 32 is pressed inward to let the engage stud 34 on the outer wall of the lock core 32 engaged in the positioning recess 272 in the accommodating chamber 27 to firmly position the lock core 32 in the fixing base 30. Lastly, the lock core 32 is pressed down to push the holding plate 36 together with the engage pin 37 to move downward. At this time, the holding plate 36 will be pressed on the spring 38 to let the spring 38 kept in an elastically compressed condition, and the lower end of the engage pin 37 will be inserted in the pin hole 42 of the positioning insert bar 41 of the resisting rod 4 for locking the resisting rod 4 in position, thus finishing assembly of the steering wheel lock.

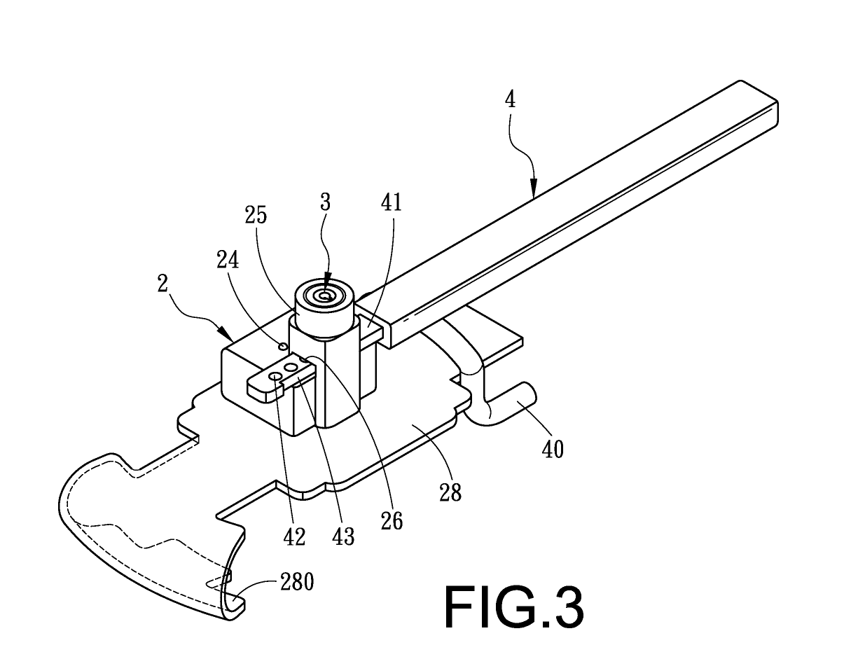

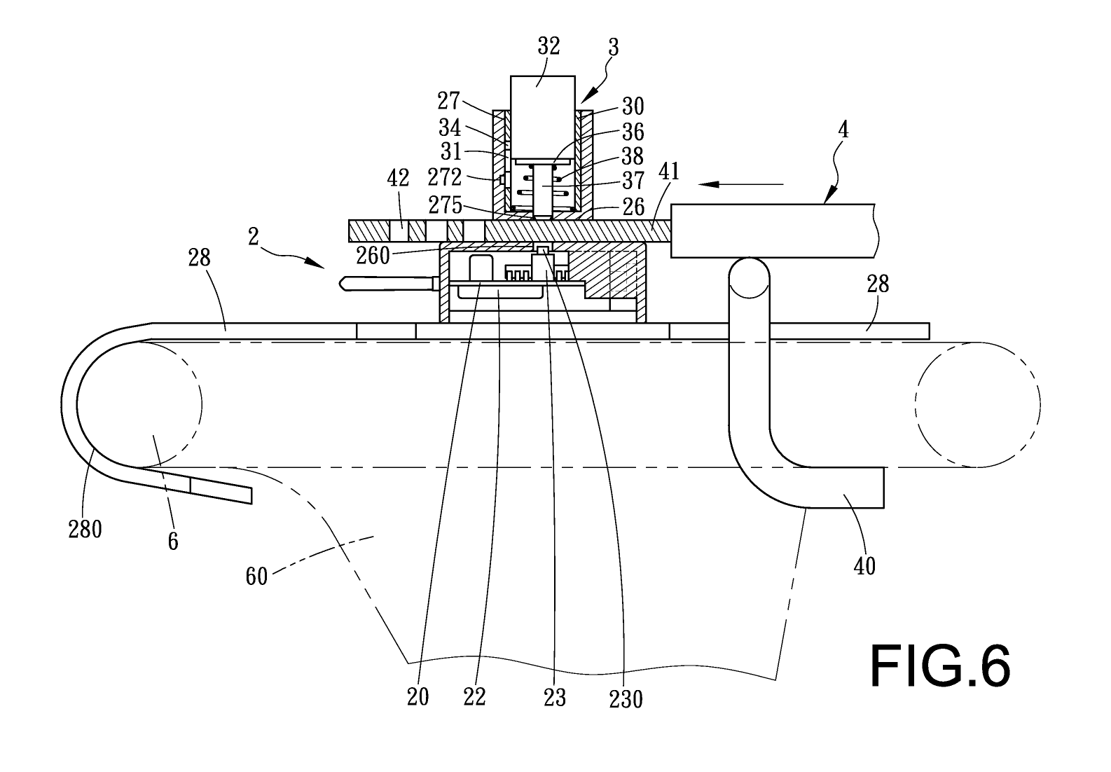

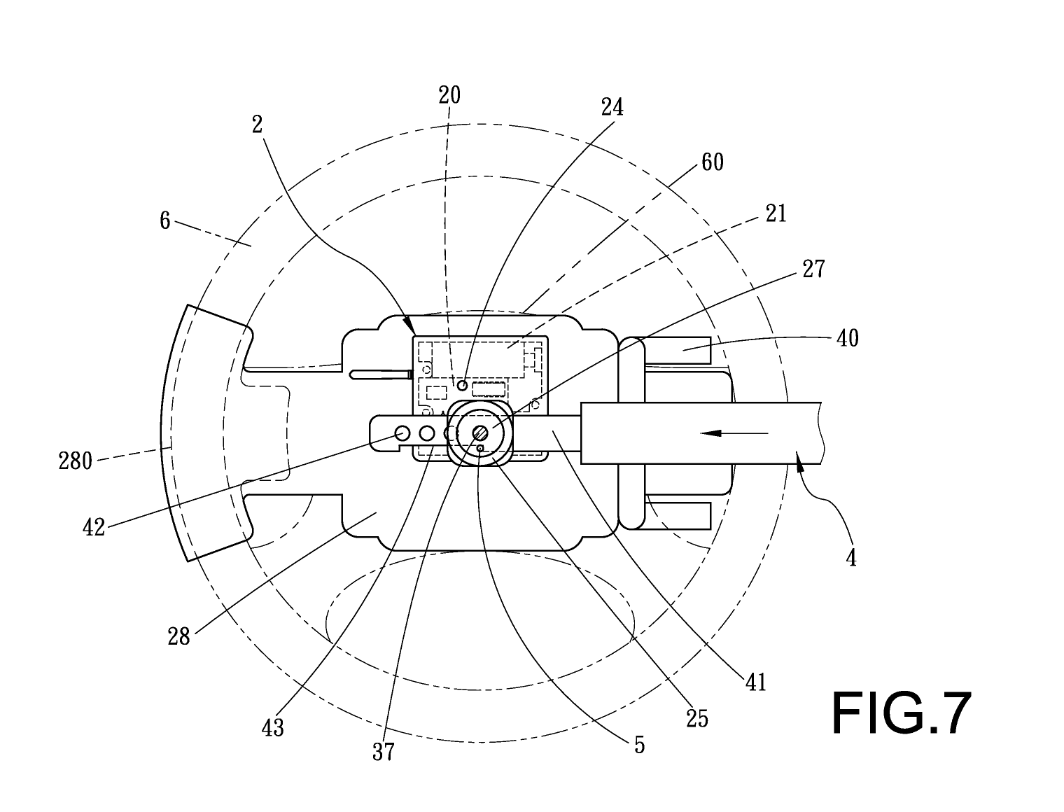

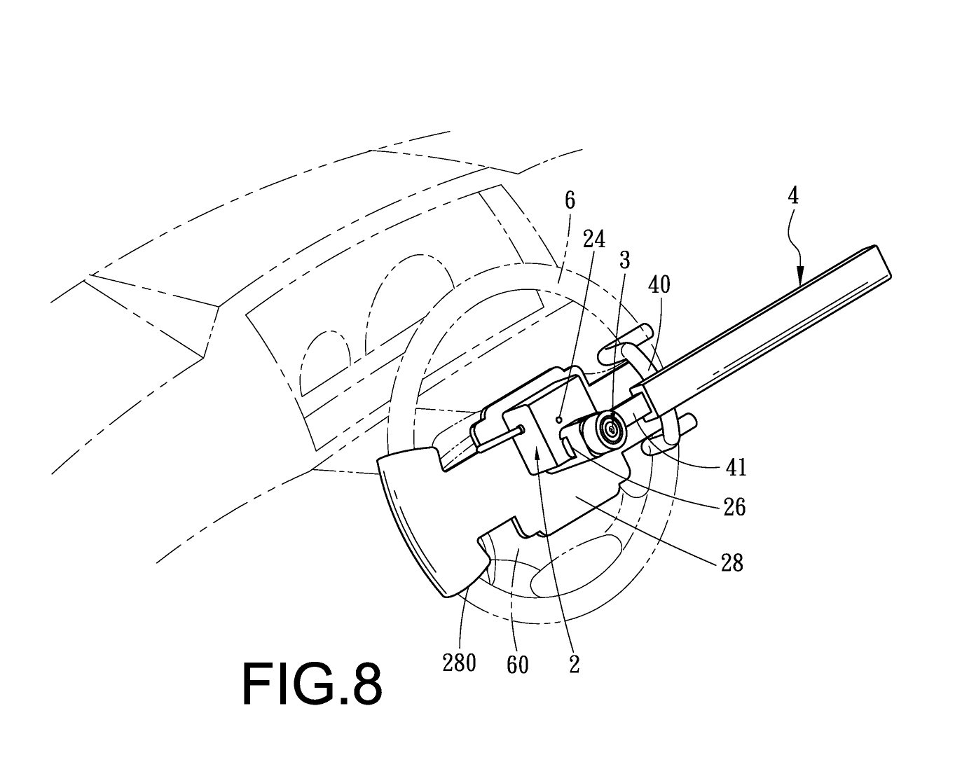

To lock the steering wheel lock on an automobile steering wheel 6, referring to FIGS. 3 to 8, firstly, the steering wheel lock is positioned across the steering wheel 6 and has the clasping recess 280 of the baffle plate 28 clasped on one side of the steering wheel 6 and the baffle plate 28 pressed on the safety airbag 60 in the center of the steering wheel 6. Next, the resisting rod 4 has its outer side pulled outward to let the retaining hook 40 of the resisting rod 4 hooked on another side of the steering wheel 6 and one of the pin holes 42 of the resisting rod 4 aligned to the insert hole 275 in the lower inner wall of the accommodating chamber 27 of the lock holder 25. Then, the lock core 32 of the push-in lock 3 is pressed down to push the holding plate 36 together with the engage pin 37 under the lock core 32 to move downward. At this time, the holding plate 36 on the engage pin 37 is pressed on the spring 38 to let the spring 38 kept in an elastically compressed condition, and the engage pin 37 is moved downward and inserted in both the insert hole 275 in the wall of the accommodating chamber 27 of the lock holder 25 and the pin hole 42 of the positioning insert bar 41 in the insert slot 26 to firmly position the positioning insert bar 41 in the insert slot 26 and prevent the positioning insert bar 41 from being pulled outward. When the engage pin 37 is moved downward and inserted in one of the pin holes 42 of the positioning insert bar 41, the lower end of the engage pin 37 will press and touch the press member 230 of the micro-switch 23 to turn on the warning lamp 24 and start the alarm system of the lock. When the lock core 32 is pressed down, the engage stud 34 on the outer wall of the lock core 32 will be moved downward and engaged in the positioning recess 272 in the circumferential wall of the accommodating chamber 27 to firmly fix the lock core 32 in the fixing base 30, thus finishing locking of the steering wheel lock.

To unlock the steering wheel lock, the lock core 32 is turned around by a key to let the engage stud 34 on the outer wall of the lock core 32 contracted inward and disengaged from the positioning recess 272 in the circumferential wall of the accommodating chamber 27 of the lock holder 25, and the spring 38 will recover its elastic force to push the holding plate 36 and the lock core 32 to move upward. Simultaneously, the engage pin 37 will be moved upward together with the holding plate 36 to have its lower end disengaged from the pin hole 42 of the positioning insert bar 41, no longer restricting the positioning insert bar 41 nor touching the press member 230 of the micro-switch 23, and hence the warning lamp 24 will be put out and the alarm system will be released. At this time, the resisting rod 4 can be pushed inward to let its retaining hook 40 no longer hooked on the steering wheel 6 to enable the steering wheel lock removed from the steering wheel 6, thus finishing unlocking of the steering wheel lock.

As can be understood from the above description, this invention has the following advantages.

1. The positioning insert bar 41 of the resisting rod 4 has one side provided with the lengthwise slide recess 43, and after the positioning insert bar 41 of the resisting rod 4 is inserted in the insert slot 26 of the foundation base 2, the fixing pin 5 fixed in the insert slot 26 is inserted in the slide recess 43 of the insert bar 41 to restrict and secure the positioning insert bar 41 in the insert slot 26 of the foundation base 2, able to prevent the resisting rod 4 from slipping off the foundation base 2 for facilitating quickly locking and unlocking of the steering wheel lock.

2. The baffle plate 28 secured on the underside of the foundation base 2 can completely block off the safety airbag 60 in the center of the steering wheel 6, able to protect the safety airbag 60 from being burglarized.

3. The resisting rod 4 can be extended outward to have its retaining hook 40 hooked on one side of the steering wheel 6 for restricting rotating angles of the steering wheel 6, achieving effect of burglary prevention of the automobile.

While the preferred embodiment of the invention has been described above, it will be recognized and understood that various modifications may be made therein and the appended claims are intended to cover all such modifications that may fall within the spirit and scope of the invention.

What is claimed is:

1. An automobile steering wheel lock comprising:
a foundation base provided thereon with a lock holder, with an insert slot formed between said lock holder and said foundation base, said lock holder disposed with an accommodating chamber having its inner wall bored with an insert hole and a pin hole, said insert hole and said pin hole communicating with said insert slot, said foundation base having its underside secured with a baffle plate, said baffle plate having its front portion formed with a clasping recess;
a push-in lock received in said accommodating chamber of said foundation base, said push-in lock provided with a fixing base fitted therein with a lock core, said lock core disposed with a holding plate under the bottom, said holding plate having its underside fixed with an engage pin, said engage pin aligned to said insert hole in an inner wall of said accommodating chamber of said lock holder, a spring fitted on said engage pin and positioned beneath said holding plate;
a resisting rod assembled at one side of said foundation base, said resisting rod having its underside secured with a retaining hook, said resisting rod having its front end fixed with a positioning insert bar, said positioning insert bar bored with at least one pin hole, said positioning insert bar having one side edge provided with a slide recess; and
a fixing pin inserted through said pin hole in an inner wall of said accommodating chamber of said lock holder and fixed in said slide recess of said positioning insert bar.

2. An automobile steering wheel lock comprising:
a foundation base disposed with a circuit board, a battery and a beeper in the interior, said circuit board installed thereon with a micro-switch and at least one warning lamp, said warning lamp extended out of a topside of said foundation base, said foundation base provided thereon with a lock holder, having an insert slot formed between said lock holder and said foundation base, said insert slot having its bottom bored with a through hole, said micro-switch provided with a press member inserted in said through hole, said lock holder formed with an accommodating chamber having its inner wall bored with an insert hole and a pin hole, said insert hole and said pin hole communicating with said insert slot, said foundation base having its underside secured with a baffle plate, said baffle plate having its front portion formed with a clasping recess;
a push-in lock received in said accommodating chamber of said foundation base, said push-in lock provided with a fixing base having a lock core fitted in its interior, said lock core having its lower side disposed with a holding plate having an engage pin fixed under its bottom, said engage pin aligned to both said insert hole in an inner wall of said accommodating chamber and said through hole at the bottom of said insert slot, a spring fitted on said engage pin and positioned beneath said holding plate;
a resisting rod assembled at one side of said foundation base, said resisting rod having a retaining hook secured at its underside, said resisting rod having its front end fixed with a positioning insert bar, said positioning insert bar bored with at least one pin hole, said positioning insert bar having one side edge cut with a slide recess; and
a fixing pin inserted through said pin hole in the inner wall of said accommodating chamber of said lock holder and fixed in said slide recess of said positioning insert bar.

3. The automobile steering wheel lock as claimed in claim 1, wherein said accommodating chamber of said lock holder has its circumferential wall bored with a pin hole and said fixing base has its outer wall bored with a positioning pin hole, a fixing pin inserted in both said pin hole of said lock holder and said positioning pin hole of said fixing base to secure said fixing base in said accommodating chamber of said lock holder.

4. The automobile steering wheel lock as claimed in claim 2, wherein said accommodating chamber of said lock holder has its circumferential wall bored with a pin hole and said fixing base has its outer wall bored with a positioning pin hole, a fixing pin inserted in both said pin hole of said lock holder and said positioning pin hole of said fixing base to secure said fixing base in said accommodating chamber of said lock holder.

5. The automobile steering wheel lock as claimed in claim 1, wherein said accommodating chamber of said lock holder has its circumferential wall bored with a positioning recess, and said fixing base of said push-in lock is provided with a slot, said lock core disposed inside with a rotary member and having its outer wall fixed with an engage stud, said engage stud inserted through said slot of said fixing base and fixed in said positioning recess of said lock holder.

6. The automobile steering wheel lock as claimed in claim 2, wherein said accommodating chamber of said lock holder has its circumferential wall bored with a positioning recess and said fixing base of said push-in lock is cut with a slot, said lock core fitted therein with a rotary member and having its outer wall secured with an engage stud, said engage stud inserted through said slot of said fixing base and fixed in said positioning recess of said lock holder.
